(19) United States
(12) Patent Application Publication
(10) Pub. No.: US 2014/0046520 A1
(43) Pub. Date: Feb. 13, 2014

(54) METHOD AND APPARATUS FOR PROVIDING HYBRID FUNCTIONALITY IN A VEHICLE

(71) Applicants: Suneet Katoch, Farmington Hills, MI (US); James C. Bestul, Freeland, MI (US)

(72) Inventors: Suneet Katoch, Farmington Hills, MI (US); James C. Bestul, Freeland, MI (US)

(73) Assignee: GM GLOBAL TECHNOLOGY OPERATIONS LLC, Detroit, MI (US)

(21) Appl. No.: 13/570,729

(22) Filed: Aug. 9, 2012

(51) Int. Cl. B60W 20/00; B60W 10/08; B60W 10/26; B60W 10/06

(52) U.S. Cl. 701/22; 903/930

(57) ABSTRACT

A method and apparatus for providing hybrid functionality aboard a vehicle having a high voltage (HV) energy storage system (ESS) electrically connected to a VITM and a battery disconnect unit (BDU) including a precharge contactor and a high voltage (HV) contactor, a voltage sensor and a controller is provided. The method includes detecting an ESS/HV bus data fault, measuring and storing an initial HV bus voltage, closing the precharge contactor in the BDU, measuring a present HV bus voltage when the precharge contactor has been closed a predetermined short time and indicating if an actual ESS/HV bus fault exists, measuring the present HV bus voltage until either the present HV bus voltage is greater than the predetermined high voltage indicating that no actual ESS/HV bus fault exists or the time the precharge contactor is closed is greater than a predetermined maximum time indicating that an actual ESS/HV bus fault exists.

### TECHNICAL FIELD

The present invention relates generally to a high voltage energy storage system aboard a hybrid electric vehicle, and more particularly to a method and apparatus for providing hybrid functionality using the high voltage energy storage system despite a data fault condition.

### BACKGROUND

Hybrid electric vehicles (HEV) can selectively utilize different energy sources as needed in order to achieve optimal fuel efficiency. One type of HEV having a full hybrid powertrain can selectively use either or both of an internal combustion engine and a high-voltage battery module or energy storage system (ESS) for electrical propulsion of the vehicle. Usually, upon startup and for speeds up to a threshold speed, a typical HEV having a full hybrid powertrain can be propelled via purely electrical means, with one or more motor/generator units (MGU) alternately drawing power from and delivering power to the ESS as needed. This type of full hybrid system may require an ESS that provides about 40-600 v. Above the threshold speed, the internal combustion engine can provide all of the required propulsive torque. Alternatively, another type of HEV having a mild hybrid powertrain lacks means for purely electrical propulsion, but retains certain fuel-saving design features of the full hybrid designs, e.g. regenerative braking capability for recharging the ESS via the MGU and the ability to selectively shut down or power off the engine at idle during Auto Stop events. This type of mild hybrid may only require an ESS that provides about 40-110 v.

The ability of the mild HEV to automatically shut off or power down the engine, or Auto Stop functionality, allows otherwise wasted fuel to be conserved during certain idle conditions. In a mild HEV having Auto Stop functionality, the high-voltage MGU can be used as a belt alternator starter (BAS) system in lieu of a conventional alternator. The BAS applies torque to a serpentine belt of the engine when a driver signals an intention to resume travel after an Auto Stop event. The torque from the MGU can turn the engine for a transient duration until a flow of fuel from the vehicle fuel supply can be restored. During cold starting of the engine, a conventional crankshaft-mounted auxiliary motor or 12-volt starter motor can provide the required amount of cranking torque.

Aboard any type of HEV, an ESS supplying high voltage electrical power to a voltage inverter within the electrical system of the HEV can become temporarily disconnected or otherwise rendered unavailable due to an ESS/HV bus data fault or an actual ESS/HV bus fault. This can result in loss of hybrid functionality, such as electrical propulsion and/or auxiliary electrical power generation, resulting in less than optimal operation due to such an ESS/HV bus fault condition.

### SUMMARY

Accordingly, a method and apparatus for providing hybrid functionality aboard a hybrid electric vehicle (HEV) having a high voltage (HV) energy storage system (ESS) electrically connected to a voltage, current, temperature module (VITM) and a battery disconnect unit (BDU) including a precharge contactor and at least one high voltage (HV) contactor, a high voltage (HV) bus voltage sensor and a controller is provided. The method includes detecting an ESS/HV bus data fault in the controller based on ESS/HV bus data received from the VITM, measuring an initial high voltage (HV) bus voltage using the HV bus voltage sensor, storing the initial HV bus voltage in the controller, closing the precharge contactor in the BDU and tracking the amount of time the precharge contactor is closed. The method further includes measuring a present HV bus voltage when the precharge contactor has been closed a predetermined short amount of time and if the present HV bus voltage is above a predetermined high voltage and the initial HV bus voltage was below a predetermined low voltage, indicating that an actual ESS/HV bus fault exists. Additionally, the method includes, if no actual ESS/HV bus fault exists when the precharge contactor has been closed the predetermined short amount of time, measuring the present HV bus voltage until one of the present HV bus voltage is greater than the predetermined high voltage indicating that no actual ESS/HV bus fault exists and the amount of time the precharge contactor is closed is greater than a predetermined maximum amount of time indicating that an actual ESS/HV bus fault exists. Finally, the method includes either opening the precharge contactor if an actual ESS/HV bus fault exists, or closing the at least one HV contactor if no actual ESS/HV bus fault exists.

An apparatus for providing hybrid functionality for the HEV despite the ESS/HV bus data fault in the controller is also provided.

A hybrid electric vehicle (HEV) includes a controller and algorithm for providing hybrid functionality for the HEV despite the ESS/HV bus data fault in the controller.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a hybrid electric vehicle (HEV) including an apparatus and method for providing hybrid functionality using a high voltage (HV) energy storage system (ESS) despite an ESS/HV bus data fault in a controller in accordance with the present invention;

FIG. 2 is a more detailed schematic illustration of the electrical circuit for the HEV of FIG. 1; and

FIG. 3 is a graphical flowchart describing the method for providing hybrid functionality for the HEV of FIG. 1.

### DETAILED DESCRIPTION

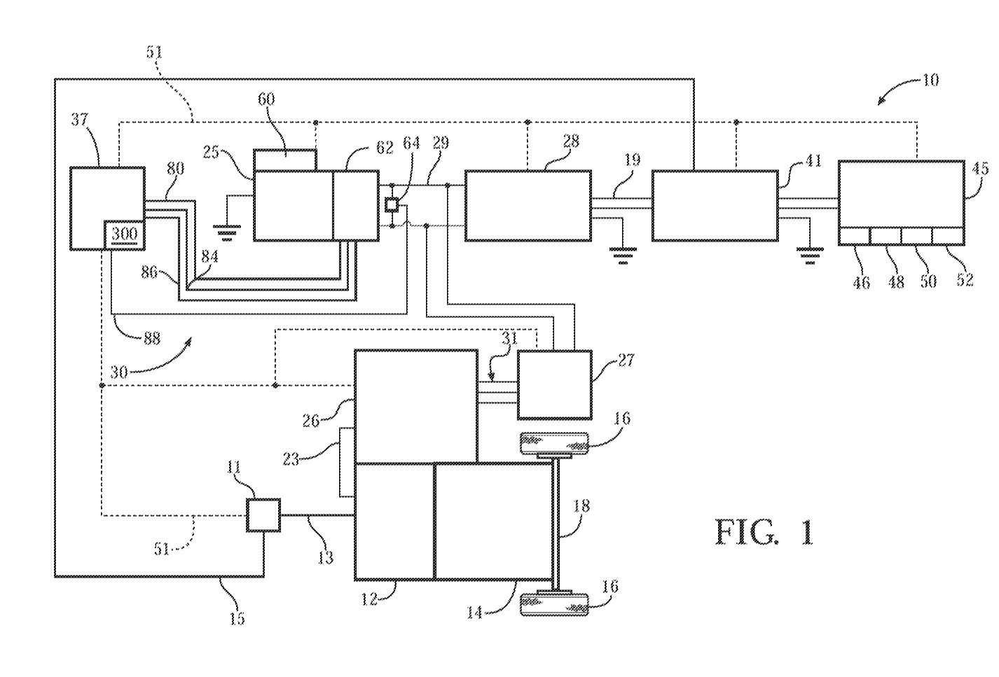

Referring to the drawings, wherein like reference numbers correspond to like or similar components throughout the several figures, and beginning with FIG. 1, a hybrid electric vehicle (HEV) 10 includes an internal combustion engine 12 having an auxiliary starter motor 11 that is generally connected through a gear set (not shown) to a crankshaft 13 of the internal combustion engine 12. The auxiliary starter motor 11 is operable for drawing electrical power from a low-voltage (LV) auxiliary battery (AUX) 41 via electrical connector 15 for cranking and starting the internal combustion engine 12 as needed, such as during an initial startup of the HEV 10 during a cold start.

The HEV 10 also includes a transmission 14 connected to the internal combustion engine 12, which has an output shaft (not shown) operatively connected with an input shaft (not shown) of the transmission 14 for providing torque to the axle 18 for driving wheels 16. The transmission 14 can be any suitable transmission, so that the HEV 10 may be a full, mild or other design of HEV as desired. Skilled artisans will appreciate that exemplary HEV 10 may include more, less or a different combination of components and/or modules than those schematically shown here, and that the present method and apparatus is not limited to this particular embodiment. One or more of the components and/or modules shown in FIG. 1 may be integrated or otherwise combined with other parts of the hybrid electric vehicle within the scope of the present invention.

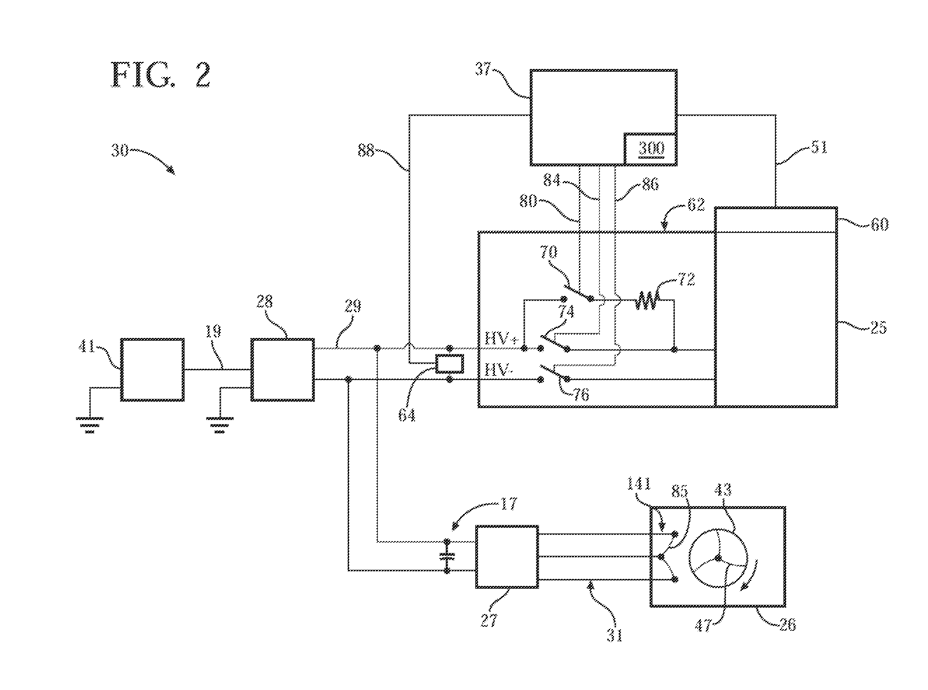

The HEV 10 includes an HV electric motor/generator unit (MGU) 26 that is electrically connected (via electrical circuit 30 shown in more detail in FIG. 2) to an HV battery or energy storage system (ESS) 25 via an HV DC bus 29, a voltage inverter or power inverter module (PIM) 27, and an HV AC bus 31. The MGU 26 may be separate as shown or may be part of the transmission 14 for operation in the HEV 10. The MGU 26 can be adapted for use in a belt alternator starter (BAS) system as described above. When configured in this manner, and during normal operation of the HEV 10, the MGU 26 can selectively rotate a serpentine belt 23 or other suitable portion of the internal combustion engine 12, thereby cranking the internal combustion engine 12 as needed. The ESS 25 can be selectively recharged via the MGU 26 when the MGU 26 is operating in its capacity as a generator, for example by capturing energy during a regenerative braking event. The ESS 25 is electrically connected to a voltage, current, temperature module (VITM) 60 and a battery disconnect unit (BDU) 62.

The HEV 10 further includes an auxiliary power module (APM) 28 which is electrically connected to the ESS 25 via the HV DC bus 29. The APM 28 is also electrically connected to the auxiliary battery (AUX) 41 via a LV bus 19. The AUX 41 is a relatively low-voltage energy storage device such as a 12-volt battery, and is suitable for powering the auxiliary starter motor 11 and one or more accessories or auxiliary (AUX) systems 45 aboard the HEV 10, for example headlights and/or interior lights 46, a radio or audio system 48, power seats 50, and electric power steering (EPS) system 52, etc.

The APM 28 is configured as a DC-DC power converter adapted to convert a supply of DC power from a high-voltage level to a low-voltage level, and vice versa, as determined by an electronic control unit or controller 37. That is, the APM 28 is operable for converting a relatively high level of voltage from the ESS 25 to a lower voltage level suitable for charging the AUX 41 and/or directly powering one or more of the auxiliary (AUX) systems 45 as needed. The controller 37 controls power flow aboard the HEV 10 from the ESS 25 and the AUX 41 to provide the required electrical or hybrid functionality.

Still referring to FIG. 1, the controller 37 is electrically connected to or otherwise in hard-wired or wireless communication with each of the internal combustion engine 12, the auxiliary starter motor 11, the MGU 26, the APM 28, the PIM 27, and the AUX 41 via a control channel 51, as illustrated by dashed lines to represent transfer conductors, e.g., a hardwired or wireless control link or path suitable for transmitting and receiving the electrical control signals necessary for proper power flow control or coordination onboard the HEV 10. The controller 37 can be configured as a distributed or a central control module having such control modules and capabilities as might be necessary to execute all required power flow control functionality aboard the HEV 10 in the desired manner. The controller 37 may include functionality of a Battery Power Inverter Module. Having the functionality of the Battery Power Inverter Module may enable the controller 37 to receive ESS/HV bus data over the control channel 51 so that under normal operating conditions, the controller 37 receives ESS 25 status information (such as voltage, current and temperature from the VITM 60) which it uses to determine whether to close a precharge contactor 70 (see FIG. 2) as discussed in more detail below. The ESS 25 status information may include percentage charge of the high voltage battery and other pertinent battery information. The controller 37 includes additional signal lines 80, 84, 86, 88 connecting to the BDU 62 and HV DC bus voltage sensor described in more detail with reference to FIG. 2.

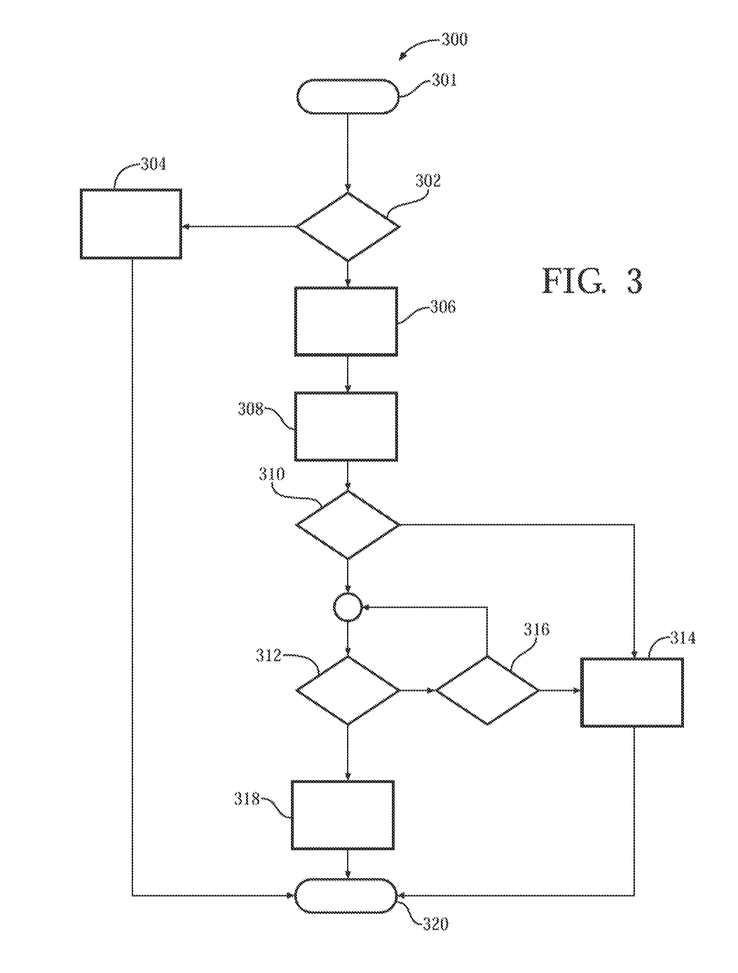

Additionally referring to FIGS. 1 and 2, the controller 37 can be configured as a general purpose digital computer generally comprising a microprocessor or central processing unit, read only memory (ROM), random access memory (RAM), electrically programmable read only memory (EPROM), high speed clock, analog to digital (A/D) and digital to analog (D/A) circuitry, and input/output circuitry and devices (I/O), as well as appropriate signal conditioning and buffer circuitry. Any algorithms resident in the controller 37 or accessible thereby, including a flow control algorithm 300 (see FIG. 3) in accordance with the invention as described, can be stored in ROM and executed to provide the respective functionality. The controller 37 may, for example, have a data sampling and algorithm run rate of 12.5 milliseconds to provide the required functionality. Within the scope of the invention, the controller 37 includes or has access to the algorithm 300 for providing hybrid functionality in the HEV 10 despite detection of an ESS/HV bus data fault and described below in detail with reference to FIG. 3.

Referring to FIG. 2, a more detailed view of the electrical circuit 30 of the HEV 10 is shown which includes the AUX 41, with the AUX 41 being electrically connected to the APM 28 via the LV bus 19. The APM 28 in turn is electrically connected to the PIM 27 via the HV DC bus 29. The MGU 26, which includes a stator 141 and a rotor 43, is electrically connected by HV AC bus 31 to the PIM 27 as shown. A field generated around coils or windings 85 of the stator 141 ultimately induces an opposing field in coils or windings 47 of the rotor 43, thereby rotating the rotor 43 as indicated in FIG. 2 by the arrow. A set of DC link capacitors 17 is positioned across the HV DC bus 29. The BDU 62 connects or disconnects the leads of the ESS 25 from the corresponding leads of the HV DC bus 29, with the corresponding leads of the HV DC bus 29 labeled HV+ and HV− in FIG. 2 for clarity. An HV bus voltage sensor 64 is electrically connected to the controller 37 via the signal line 88 to the HV DC bus 29 on the side of the BDU 62 opposite connections to the ESS 25.

The BDU 62 includes the precharge contactor 70 in series with a precharge resistor 72 both of which are connected in parallel with the HV+ contactor 74. An HV− contactor 76 may also be connected. Precharge contactor 70, HV+ contactor 74 and HV− contactor 76 may be a high-voltage switch, relay or contactor and may be positioned in such a way as to disconnect one or both of the leads of the ESS 25 from the corresponding leads of the HV DC bus 29. Signal lines 80, 84 and 86 respectively electrically connect the controller 37 with the precharge contactor 70, the HV+ contactor 74, and the HV− contactor 76 to enable the controller 37 to open and close the respective contactors as required for normal hybrid operations and as indicated by the algorithm 300 in accordance with the present invention as described in greater detail hereinbelow. In normal hybrid operation, the controller 37 signals the precharge contactor 70 to close so that the ESS 25 can be brought online in a controlled manner. Once the precharge contactor 70 has reached a predetermined threshold voltage, then the HV+ contactor 74 is closed, and the precharge contactor 70 is opened. This predetermined threshold voltage may, for example, be greater than 95% of measured ESS voltage as conveyed by the VITM 60 via the control channel 51 to the controller 37.

Referring to FIG. 3, the algorithm 300 starts, in step 301, when there is a need for hybrid functionality such as when the ignition transitions to “run” and in step 302, the controller 37 checks if an ESS/HV bus data fault is detected. An ESS/HV bus data fault may occur when either the ESS/HV bus data received is invalid ESS/HV bus data or there is an indication that no ESS/HV bus data is available to be received from the VITM 60. Either of these conditions may be caused by a communication error between the VITM 60 and the controller 37, a disconnected or faulty sensor of the VITM 60, an erroneous ESS measurement sent to the controller 37, or other such malfunctions. If no ESS/HV bus data fault is detected, then the algorithm 300 proceeds to step 304 and begins the normal procedures to bring the ESS 25 on-line so that hybrid functionality is provided. As no ESS/HV bus data fault was detected, the controller 37 ends the algorithm 300 in step 320.

Referring still to FIG. 3, if in step 302, the algorithm 300 determines that an ESS/HV bus data fault has been detected in the controller 37, the algorithm 300 proceeds to step 306 where an initial high voltage (HV) bus voltage is measured and stored before sending a signal on signal line 80 for the precharge contactor 70 to close. Next in step 308, the precharge contactor 70 in the BDU 62 is closed and the amount of time is tracked in the controller 37 as t_{pcc} (time precharge contactor closed). Next in step 310, when the precharge contactor 70 has been closed for a predetermined short amount of time, the present HV bus voltage is measured. If the present HV bus voltage is above a predetermined high voltage and the initial HV bus voltage was below a predetermined low voltage, then the algorithm 300 proceeds to step 314. In step 314, it is indicated that an actual ESS/HV bus fault has occurred, so the algorithm 300 opens the precharge contactor 70 and does not allow the HV+ contactor 74 to close. Thus hybrid functionality is not enabled due to the presence of an actual ESS/HV bus fault.

Still referring to FIG. 3, in step 310, if the present HV bus voltage is not above the predetermined high voltage when the precharge contactor 70 has been closed the predetermined short amount of time and the initial HV bus voltage was below the predetermined low voltage, the algorithm 300 proceeds to step 312 to determine if the present HV bus voltage is above the predetermined high voltage. (It may not be on the first time through this loop.) The algorithm 300 proceeds to step 316 to determine if the time the precharge contactor 70 has been closed is less than the predetermined maximum amount of time (tₘₐₓ). If the precharge contactor 70 has not been closed the predetermined maximum amount of time, the algorithm 300 returns to step 312, where the HV bus voltage is again checked to determine if the present HV bus voltage is above the predetermined high voltage. If the present HV bus voltage is above the predetermined high voltage, the algorithm 300 proceeds to step 318. In step 318, since no actual ESS/HV bus fault was detected, the controller 37 closes at least the HV+ contactor 74 and brings the ESS 25 on-line. This enables the HEV 10 to have hybrid functionality despite an ESS/HV bus data fault being detected in the controller 37 in step 302. As no actual ESS/HV bus data fault was detected, the controller 37 ends the algorithm 300 in step 320.

If in step 312, the HV bus voltage is below the predetermined high voltage, the algorithm proceeds to step 316. If the time the precharge contactor 70 has been closed is not below the predetermined maximum amount of time, then the algorithm 300 proceeds to step 314 as an actual ESS/HV bus fault has been determined. As an actual ESS/HV bus data fault was detected, the controller 37 ends the algorithm 300 in step 320.

To further clarify, there are two fault modes in which the algorithm 300 in the controller 37 may have indicated that an actual ESS/HV bus fault exists in step 314 (causing the loss of hybrid functionality). In a first fault mode, the controller 37 checks, when the precharge contactor 70 has been closed the predetermined short amount of time (for example, 75 milliseconds), if the present HV bus voltage value is above the predetermined high voltage (for example, 100 volts) and the initial HV bus voltage was below the predetermined low voltage (for example, 40 volts). If this first fault mode is detected, the controller 37 signals that no capacitance was detected on the HV DC bus 29 so the precharge voltage was rising too fast. In a second fault mode, the controller 37 checks if the present HV bus voltage is still below the predetermined high voltage (for example, 100 volts) after the predetermined maximum amount of time (tₘₐₓ) (for example, 1 second). If this second fault mode is detected, the controller 37 signals that the HV DC bus 29 is experiencing either a shorted or an open fault condition. Since an actual ESS/HV bus fault exists (either the first fault mode or the second fault mode), the controller 37 does not allow hybrid functionality. An actual ESS/HV bus fault may prevent all hybrid functionality and may result in the discharge of the 12 v. battery.

The values of 75 milliseconds for the predetermined short amount of time, one second for the predetermined maximum amount of time, 40 volts for the predetermined low voltage and 100 volts for the predetermined high voltage were determined for a hybrid system having a high voltage battery voltage of around 115 volts. The values selected for a specific system are variable depending on the system design itself. Such system design criteria may include the contactor hardware and materials used. The system should be designed so that a too fast precharge voltage ramp up or other worst case battery condition would be detected, and the circuit opened before the contactor was welded or otherwise damaged. Specifically, the predetermined short amount of time and the predetermined high voltage values are selected to avoid damage to the precharge contactor. In general, the predetermined thresholds should be selected such that the system is able to detect a failure reliably.

Throughout the description above, the term hybrid functionality is meant to encompass provision of electrical propulsion, provision of auxiliary electrical power, or other features using the ESS 25 depending on the type of HEV 10 or other design selections in which the present invention is incorporated.

In the embodiment shown in FIG. 2, when either the precharge contactor 70 or the HV+ contactor 74 are signaled to open or close via signal lines 80 and 84 respectively, the HV− contactor 76 will be signaled over signal line 86 to open or close as needed.

The precharge contactor 70 has a resistor 72 having a nominal value based on a design criteria that enables the BDU 62 to ramp up the high voltage so that the main contactor(s) 74, 76 do not have too much current draw across them causing them to malfunction or possibly even weld shut. In one exemplary embodiment, the precharge resistor may be 6.8 ohm with a 50 watt capacity and a tolerance of 5%.

While the best modes for carrying out the invention have been described in detail, those familiar with the art to which this invention relates will recognize various alternative designs and embodiments for practicing the invention within the scope of the appended claims.

1. A method for providing hybrid functionality aboard a hybrid electric vehicle (HEV) having a high voltage (HV) energy storage system (ESS) electrically connected to a voltage, current, temperature module (VITM) and a battery disconnect unit (BDU) including a precharge contactor and at least one high voltage (HV) contactor, a high voltage (HV) bus voltage sensor and a controller, the method comprising:
detecting an ESS/HV bus data fault in the controller based on ESS/HV bus data received from the VITM;
measuring an initial high voltage (HV) bus voltage using the HV bus voltage sensor;
storing the initial HV bus voltage in the controller;
closing the precharge contactor in the BDU and tracking the amount of time the precharge contactor is closed;
measuring a present HV bus voltage when the precharge contactor has been closed a predetermined short amount of time and if the present HV bus voltage is above a predetermined high voltage and the initial HV bus voltage was below a predetermined low voltage, indicating that an actual ESS/HV bus fault exists;
if no actual ESS/HV bus fault exists when the precharge contactor has been closed the predetermined short amount of time, measuring the present HV bus voltage until one of the present HV bus voltage is greater than the predetermined high voltage indicating that no actual ESS/HV bus fault exists and the amount of time the precharge contactor is closed is greater than a predetermined maximum amount of time indicating that an actual ESS/HV bus fault exists; and
one of:
opening the precharge contactor if an actual ESS/HV bus fault exists; and
closing the at least one HV contactor if no actual ESS/HV bus fault exists.

2. The method of claim 1 wherein detecting an ESS/HV bus data fault in the controller based on ESS/HV bus data received from the VITM includes determining that the ESS/HV bus data received is invalid data.

3. The method of claim 1 wherein detecting an ESS/HV bus data fault in the controller based on ESS/HV bus data received from the VITM includes determining that no ESS/HV bus data is received from the VITM.

4. The method of claim 1 wherein the predetermined short amount of time and the predetermined high voltage are selected to avoid damage to the precharge contactor.

5. The method of claim 1 wherein the predetermined maximum amount of time is approximately one second.

6. An apparatus for providing hybrid functionality in a hybrid electric vehicle comprising:
a high voltage (HV) bus having an HV bus voltage sensor;
a high voltage energy storage system (ESS) for providing hybrid functionality using the HV bus;
a battery disconnect unit (BDU) having a precharge contactor and at least one HV contactor for connecting the ESS to the HV bus;
a voltage, current, temperature module (VITM) for sensing a status of the ESS; and
a controller having an algorithm for detecting an ESS/HV bus data fault in the controller based on ESS/HV bus data received from the VITM, measuring an initial HV bus voltage using the HV bus voltage sensor, storing the initial HV bus voltage in the controller, closing the precharge contactor in the BDU and tracking the amount of time the precharge contactor is closed, measuring a present HV bus voltage when the precharge contactor has been closed a predetermined short amount of time and if the present HV bus voltage is above a predetermined high voltage and the initial HV bus voltage was below a predetermined low voltage, indicating that an actual ESS/HV bus fault exists, and if no actual ESS/HV bus fault exists when the precharge contactor has been closed the predetermined short amount of time, measuring the present HV bus voltage until one of the present HV bus voltage is greater than the predetermined high voltage indicating that no actual ESS/HV bus fault exists and the amount of time the precharge contactor is closed is greater than a predetermined maximum amount of time indicating that an actual ESS/HV bus fault exists, and one of opening the precharge contactor if an actual ESS/HV bus fault exists and closing the at least one HV contactor if no actual ESS/HV bus fault exists.

7. The apparatus of claim 6 wherein detecting an ESS/HV bus data fault in the controller based on ESS/HV bus data received from the VITM includes determining that the ESS/HV bus data received is invalid data.

8. The apparatus of claim 6 wherein detecting an ESS/HV bus data fault in the controller based on ESS/HV bus data received from the VITM includes determining that no ESS/HV bus data is received from the VITM.

9. The apparatus of claim 6 wherein the predetermined short amount of time and the predetermined high voltage are selected to avoid damage to the precharge contactor.

10. The apparatus of claim 6 wherein the predetermined maximum amount of time is approximately one second.

11. A hybrid electric vehicle (HEV) comprising:
an internal combustion engine;
a motor/generator unit;
a transmission connected to the internal combustion engine and the motor/generator unit for providing torque for propelling the vehicle;
a high voltage (HV) bus having an HV bus voltage sensor;
a high voltage energy storage system (ESS) for providing hybrid functionality using the HV bus;
a battery disconnect unit (BDU) having a precharge contactor and at least one HV contactor for connecting the ESS to the HV bus;
a voltage, current, temperature module (VITM) for sensing a status of the ESS; and
a controller having an algorithm for detecting an ESS/HV bus data fault in the controller based on ESS/HV bus data received from the VITM, measuring an initial HV bus voltage using the HV bus voltage sensor, storing the initial HV bus voltage in the controller, closing the precharge contactor in the BDU and tracking the amount of time the precharge contactor is closed, measuring a present HV bus voltage when the precharge contactor has been closed a predetermined short amount of time and if the present HV bus voltage is above a predetermined high voltage and the initial HV bus voltage was below a predetermined low voltage, indicating that an actual ESS/HV bus fault exists, and if no actual ESS/HV bus fault exists when the precharge contactor has been closed the predetermined short amount of time, measuring the present HV bus voltage until one of the present HV bus voltage is greater than the predetermined high voltage indicating that no actual ESS/HV bus fault exists and the amount of time the precharge contactor is closed is greater than a predetermined maximum amount of time indicating that an actual ESS/HV bus fault exists, and one of opening the precharge contactor if an actual ESS/HV bus fault exists and closing the at least one HV contactor if no actual ESS/HV bus fault exists.

12. The HEV of claim 11 wherein detecting an ESS/HV bus data fault in the controller based on ESS/HV bus data received from the VITM includes determining that the ESS/HV bus data received is invalid data.

13. The HEV of claim 11 wherein detecting an ESS/HV bus data fault in the controller based on ESS/HV bus data received from the VITM includes determining that no ESS/HV bus data is received from the VITM.

14. The HEV of claim 11 wherein the predetermined short amount of time and the predetermined high voltage are selected to avoid damage to the precharge contactor.

15. The HEV of claim 11 wherein the predetermined maximum amount of time is approximately one second.
